(19) United States
(12) Patent Application Publication
(10) Pub. No.: US 2005/0223404 A1
(43) Pub. Date: Oct. 6, 2005

(54) Digital broadcasting receiver, digital signal processor, and control method for digital broadcasting receiver

(75) Inventors: Masao Ishiguro, Kawasaki (JP); Yukio Fujii, Yokohama (JP); Atsuo Kawaguchi, Sagamihara (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 11/061,797

(22) Filed: Feb. 17, 2005

(30) Foreign Application Priority Data
Apr. 1, 2004 (JP) 2004-109395

(51) Int. Cl. H04N 5/217

(52) U.S. Cl. 725/38

(57) ABSTRACT

An apparatus and a control method for an apparatus includes: a tuner for transmitting a demodulation signal which is a signal generated by demodulating a receiving signal of a digital broadcast; a digital signal processor for decoding the demodulation signal and transmitting a first video signal to an external device; a general-purpose processor for generating a second video signal to be synthesized with the first video signal; a video signal synthesizing circuit for synthesizing the second video signal with the first video signal; and a user interface for accepting from the external device an input of a starting signal which is a signal instructing a start of video signal output. The digital signal processor and the general-purpose processor start respective boot sequences in response to the acceptance of input of the starting signal by the user interface, and the digital signal processor starts the decoding of the demodulation signal before the boot sequence of the general-purpose processor is completed.

### CROSS-REFERENCES TO RELATED APPLICATIONS

The present application is related to and claims priority from Japanese Patent Application No. 2004-109395, filed Apr. 1, 2004, and is hereby incorporated by reference for all purposes.

### BACKGROUND OF THE INVENTION

The present invention relates to a digital broadcasting receiver, a digital signal processor, and a control method for a digital broadcasting receiver.

In recent years, the progress of video compression technology, the improvement of LSI in packaging/mounting density and operation speed, and other advancements in digital technology have accelerated the digitization of broadcasts, and CS broadcasting, BS broadcasting, and digital cable TV broadcasting are already started. Terrestrial TV broadcasting is also planned to terminate analog broadcasting sometime in the future and to be totally switched to digital broadcasting (refer to, for example, ARIB STD B-10, one of the standards established by the “Association of Radio Industries and Businesses” of Japan).

In digital broadcasting, data broadcasting for delivering character information, static image information, and other data, is being conducted in addition to TV broadcasting and audio broadcasting. In data broadcasting, the provision of interactive contents, intended to display information in response to the input information sent from the viewer, is also already started. Receivers for receiving these digital broadcasts are required to have not only functions relating to output processing of TV broadcasting and audio broadcasting video signals and audio signals, but also further advanced other functions and multifarious functions. These functions include, for example, a function that displays diversified data based on data broadcasting, and a function that establishes connection to a communications networks such as the Internet, and transmits, to a broadcasting station via the communications network, input information that has been entered from a remote control unit by the viewer. In order to realize such functional enhancement and multifunctionality, digital broadcasting receivers are coming to employ the general-purpose operating systems having a variety of functions such as transmitting and receiving data respect to devices and processing communications protocols. General-purpose operating systems are abundant in function, whereas their startup is usually a time-consuming operation since various functions require initialization.

Viewers who have been familiar with conventional analog TV broadcasts and the like are expecting to be provided with output of video immediately after powering on the TV receiver, even for digital broadcasts. To satisfy these needs of viewers, designs are required to pay consideration to the above-mentioned time-consuming startup of the operating systems.

### BRIEF SUMMARY OF THE INVENTION

The present invention was made in consideration of the above problem, and provides a digital broadcasting receiver and TV apparatus capable of transmitting video signals immediately on startup, and a digital broadcasting receiver control method allowing the transmission.

The present invention is a digital broadcasting receiver including: a tuner for transmitting the demodulation signal obtained by demodulating a digital broadcast receiving signal; a digital signal processor for decoding the demodulation signal and transmitting a first video signal to the outside; a general-purpose processor for generating a second video signal to be synthesized with the first video signal; a video signal synthesizing circuit for synthesizing the second video signal with the first video signal; and a user interface for accepting, from outside, input of a starting signal which is a signal instructing a start of video signal output.

In this receiver, the digital signal processor and the general-purpose processor each starts a boot sequence in response to the acceptance of input of the starting signal by the user interface, and the digital signal processor starts decoding the demodulation signal before the general-purpose processor completes the boot sequence.

According to the present invention, it is possible to provide a digital broadcasting receiver and TV apparatus capable of transmitting video signals immediately on startup, and a digital broadcasting receiver control method allowing the transmission.

### BRIEF DESCRIPTION OF THE DRAWINGS

These and other features, objects and advantages of the present invention will become more apparent from the following description when taken in conjunction with the accompanying drawings wherein:

FIG. 1 is a diagram showing a configuration of a digital broadcasting receiver 100 according to an embodiment of the present invention;

FIG. 2 is a diagram that explains the structure of a transport packet;

FIG. 3 is a diagram showing an example of a BML document for writing the contents of a data broadcast;

FIG. 4 is a functional block diagram of a DSP 2 in the above embodiment of the present invention;

FIG. 5 is a diagram showing the structure of setup information 9 in the above embodiment of the present invention;

FIG. 6 is a diagram showing an example of the service number correspondence table 22 used in the above embodiment of the present invention;

FIG. 7 is a diagram showing another example of the receiving-frequency correspondence table 23 in the above embodiment of the present invention;

FIG. 8 is a diagram showing an example of the flow of processing during the startup of the digital broadcasting receiver 100 in the above embodiment of the present invention;

FIG. 9 is a diagram showing an example of PAT which is one constituent element of PSI;

FIG. 10 is a diagram showing an example of PMT which is another constituent element of PSI;

FIG. 11 is a diagram showing the flow of processing during the boot sequence of the DSP 2 in the above embodiment of the present invention;

FIG. 12 is a diagram showing the flow of the process conducted when the digital broadcasting receiver 100 in the above embodiment of the present invention is powered off;

FIG. 13 is a diagram showing another configuration of the digital broadcasting receiver 100 in the above embodiment of the present invention;

FIG. 14 is a diagram showing another example of the flow of processing during the startup of the digital broadcasting receiver 100 in the above embodiment of the present invention;

FIG. 15 is a diagram showing yet another example of the flow of processing during the startup of the digital broadcasting receiver 100 in the above embodiment of the present invention;

FIG. 16 is a diagram showing a further example of the flow of processing during the startup of the digital broadcasting receiver 100 in the above embodiment of the present invention;

FIG. 17 is a diagram showing yet another configuration of the digital broadcasting receiver 100 in the above embodiment of the present invention; and

FIG. 18 is a diagram showing an example of NIT which is yet another constituent element of PSI.

### DETAILED DESCRIPTION OF THE INVENTION

Apparatus Configuration

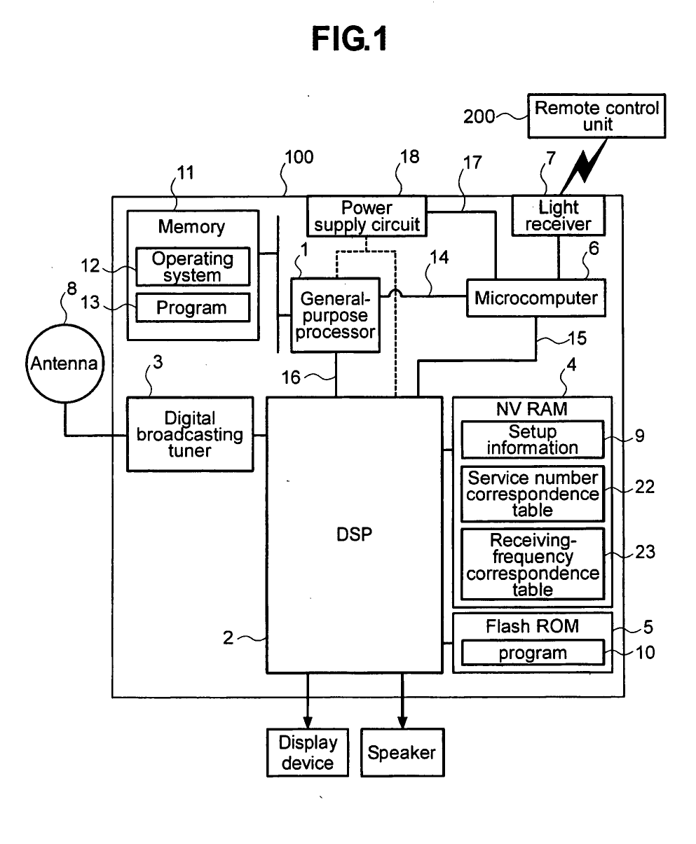

FIG. 1 is a diagram showing a configuration of a digital broadcasting receiver 100 for receiving a digital broadcast and transmitting video signals and audio signals according to an embodiment of the present invention. As shown in FIG. 1, the digital broadcasting receiver 100 has a general-purpose processor 1, a memory 11, a digital signal processor (DSP) 2, a digital broadcasting tuner 3, a nonvolatile random-access memory (NVRAM) 4, a flash read-only memory (ROM) 5, a microcomputer 6, a light receiver 7, and a power supply circuit 18.

The light receiver 7 receives from a remote control unit 200 a keycode (e.g., video signal output starting or stopping signal) which is information identifying the key of the remote control unit 200 that has been pressed by a user. That is to say, the light receiver 7 functions as a user interface that accepts input of keycodes from the user.

The microcomputer 6 (remote control signal receiving circuit), after receiving the keycode from the light receiver 7, transfers the keycode to the DSP 2 through a bus 15 and to the general-purpose processor 1 through a bus 14. Electric power is supplied from a built-in battery (not shown) of the digital broadcasting receiver 100 to the microcomputer 6 so that even when AC power is not supplied to the digital broadcasting receiver 100, the microcomputer 6 can receive keycodes from the remote control unit 200.

The power supply circuit 18 supplies electric power to the digital broadcasting receiver 100. The microcomputer 6, when receiving a keycode that identifies a “POWER” key of the remote control unit 200, turns on or off the power supplied to the digital broadcasting receiver 100. For example, if the microcomputer 6 receives the keycode of the “POWER” key when the digital broadcasting receiver 100 is powered off, the power supply circuit 18 supplies power to the general-purpose processor 1, the DSP 2, and other elements. The microcomputer 6 may also be composed to be powered from the power supply circuit 18. In this case, the power supply circuit 18 supplies power to the microcomputer 6, even if the power to the digital broadcasting receiver 100 is off.

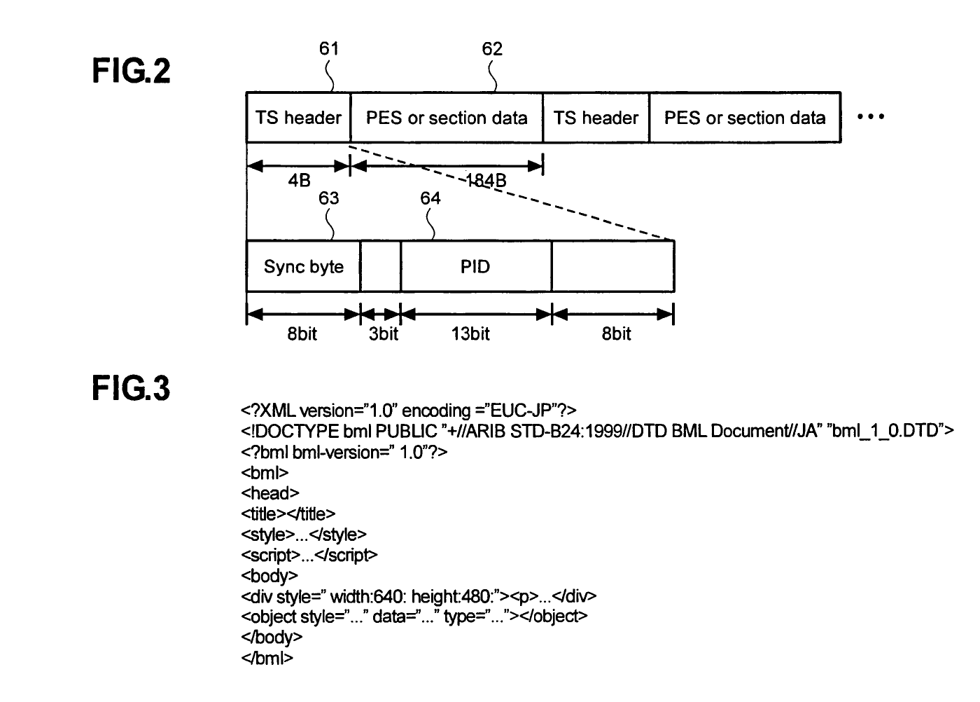

The digital broadcasting tuner 3 demodulates a receiving signal of the digital broadcast received by the antenna 8, and outputs a transport stream that is the demodulation signal generated by the modulation. The transport stream is constructed of a transport packet compliant with a standard of MPEG2-TS (Moving Pictures Experts Group, Transport Stream). The structure of the transport packet is shown in FIG. 2. Video, audio, and other data streams are stored in split form in a payload part 62 of the transport packet.

The DSP 2 decodes the transport stream output from the digital broadcasting tuner 3, and outputs a video signal of a TV broadcast or an audio signal of an audio broadcast, to an output device such as a display device or a loudspeaker. The DSP 2 also conducts control such as setting a receiving frequency for the digital broadcasting tuner 3. The video signal generated by the DSP 2 decoding the transport stream is referred to for discussion purposes as a first video signal.

The flash ROM 5 is a memory that stores a program 10 which the DSP 2 executes. By executing the program 10 stored within the flash ROM 5, the DSP 2 realizes a function that sets up the digital broadcasting tuner 3 for operation, a function that decodes the transport stream, and various other functions. The program 10 may also be broadcast as contents of a data broadcast. In this case, the DSP 2 receives the program 10 and stores the program into the flash ROM 5. This makes it possible to upgrade the program 10.

The NVRAM 4 is a nonvolatile access memory for storing setup information 9, a service number correspondence table 22, and a receiving-frequency correspondence table 23. These kinds of information are needed to output a video signal by decoding the transport stream output from the digital broadcasting tuner 3. The setup information 9, the service number correspondence table 22, and the receiving-frequency correspondence table 23 are detailed on later pages.

The general-purpose processor 1 generates a second video signal to be synthesized with the first video signal. The second video signal is a signal for outputting a display screen. This screen may be, for example, an information display screen for displaying an EPG (Electronic Program Guide) that is a digital broadcasting program list (schedule), and contents of data broadcasts. The screen may otherwise be an OSD (On-Screen Display) screen for displaying information such as GUI (Graphical User Interface) information for operational setup of the digital broadcasting receiver, and/or service numbers for identifying the programming/scheduling channels (hereinafter, referred as to services) that the DSP 2 outputs. The contents of the data broadcast are written in the descriptive format that uses BML (Broadcast Markup Language), a language for displaying character information, static images, and the like, in specific colors or in specific layout forms. FIG. 3 shows an example of a BML document. Hereinafter, the data written in the BML descriptive format is referred to as a BML document, and a screen for displaying the BML document is referred to as a BML screen.

The general-purpose processor 1 executes an operating system 12 previously stored within the memory 11. For example, Linux® or Windows® can be used as the operating system 12. Use of the functions provided by a general-purpose operating system allows development efficiency of the digital broadcasting receiver to be improved. Also, reuse of the highly reliable application programs that have already been proven to operate properly on a general-purpose operating system allows development costs to be reduced and reliability of the digital broadcasting receiver to be improved. Costs can be further reduced by adopting an operating system that can be used free of cost, such as Linux (registered trademark). The general-purpose processor 1 realizes various functions such as the above-mentioned function for generating an EPG or BML screen, by executing an application program 13. The digital broadcasting receiver 100 may also be equipped with a hard disk (or any other type of storage device) so that the operating system 12 and the application program 13 will be stored into the hard disk.

Function Blocks of the DSP 2

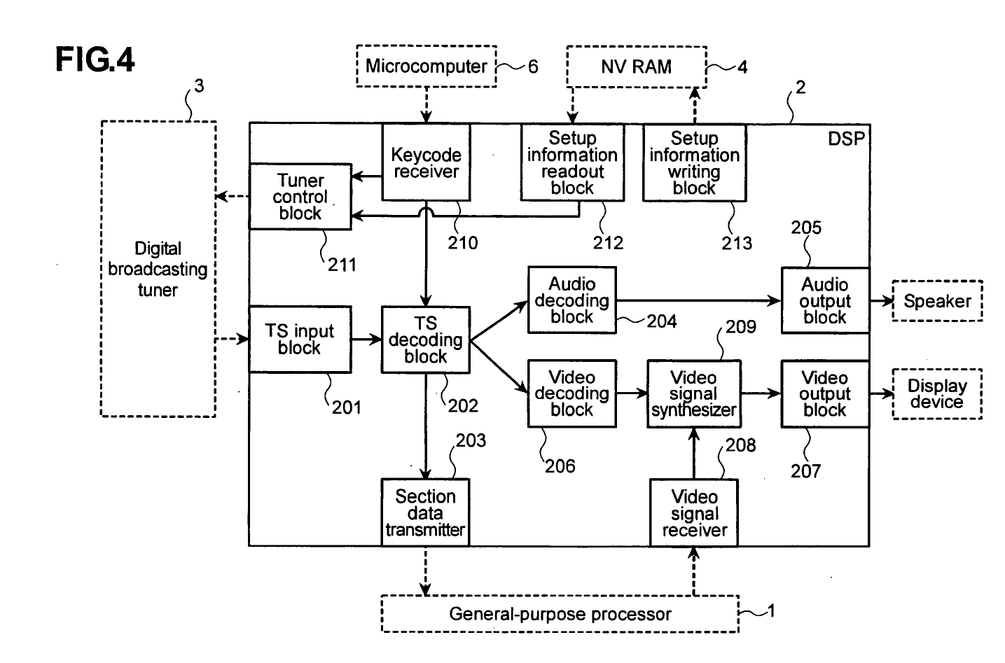

FIG. 4 is a functional block diagram of the DSP 2. As shown in FIG. 4, the DSP 2 has a TS (Transport Stream) input block 201, a TS decoding block 202, a section data transmitter 203, an audio decoding block 204, an audio output block 205, a video decoding block 206, a video signal receiver 208, a video signal synthesizer 209, a keycode receiver 210, a tuner control block 211, a setup information readout block 212, and a setup information writing block 213.

The TS input block 201 accepts input of the transport stream output from the digital broadcasting tuner 3.

The TS decoding block 202 extracts a transport packet associated with a specific service. The extraction is described later herein. After extracting the transport stream, the TS decoding block 202 connects the data stored within the payload part 62 of the transport packet, and reconstructs data streams (hereinafter, elementary streams) such as video, audio, or caption data, and the section-format data delivered during data broadcasting or the like (hereinafter, the section-format data is referred to as section data). The elementary streams and section data are multiplexed in a transport stream as the “PES (Packetized Elementary Stream)” or “sections” standardized in MPEG2-TS.

The section data transmitter 203 transmits the section data that the TS decoding block 202 has reconstructed, to the general-purpose processor 1. A TS packet transmitter for transmitting the transport packet that contains section data, to the general-purpose processor 1, may be provided instead of the section data transmitter 203. In that case, the general-purpose processor 1 reconstructs data of the section format. A processing load on the DSP 2 is thus reduced.

The audio decoding block 204 decodes an audio elementary stream into audio signal data. The audio output block 205 outputs the audio signal data generated by decoding within the audio decoding block 204, to an external output device such as a loudspeaker.

The video decoding block 206 decodes a video or caption elementary stream into a first video signal. The video output block 207 outputs the first video signal generated by decoding within the video decoding block 206, to the external output device such as a loudspeaker.

The video signal synthesizer 209 synthesizes the first video signal generated by decoding within the video decoding block 206, and the second video signal received from the general-purpose processor 1 by the video signal receiver 207. The video signal synthesizer 209 also synthesizes the video signal generated by decoding within the video decoding block 206, and the video caption signal.

The keycode receiver 210 receives from the microcomputer 6 the keycode that was transmitted from the remote control unit 200.

The tuner control block 211 controls the digital broadcasting tuner 3. The tuner control block 211 sets a receiving frequency of the radio waves received by the digital broadcasting tuner 3, in response to, for example, the keycode received by the keycode receiver 210.

The setup information readout block 212 reads setup information 9 out from the NVRAM 4, and the setup information writing block 213 writes the setup information 9 into the NVRAM 4.

The above functions are realized by the DSP 2 executing the program 10 stored within the flash ROM 5.

Information Stored into the NVRAM 4

An example of setup information 9 is shown in FIG. 5. The setup information 9 includes a last service number field 21, a user age field 24, a video format field 25, an optical digital output format field 26, a caption display/language information field 27, and an OSD display setup information field 28.

A service number (service information) of a service associated with the first video signal that was last output immediately before the digital broadcasting receiver 100 was powered off is set in the last service number field 21.

Information that identifies an age of the user of the digital broadcasting receiver 100 as an attribute, is set in the user age field 24. The digital broadcasting receiver 100 receives the age that the user has input using the remote control unit 200, for example, and sets the age in the user age field 24.

A value that identifies magnitude of the video signal output from the DSP 2 is set in the video format field 25. A value identifying an aspect ratio of, for example, “4:3” or “16:9” of the video signal is set in the video format field 25.

A value identifying the format of digital audio signals that is used for the digital broadcasting receiver 100 to output audio data to the outside is set in the optical digital output format field 26. The format of digital audio signals that is set in the optical digital output format field 26 is, for example, “PCM” (Pulse Code Modulation) or “AAC” (Advanced Audio Coding).

Whether a caption is to be displayed, in what language the caption is to be displayed, and other information are set in the caption display/language information field 27.

A value indicating whether an OSD screen for displaying a service number, a program name, and others is to be output for the video signal output from the DSP 2 is set in the OSD display setup information field 28.

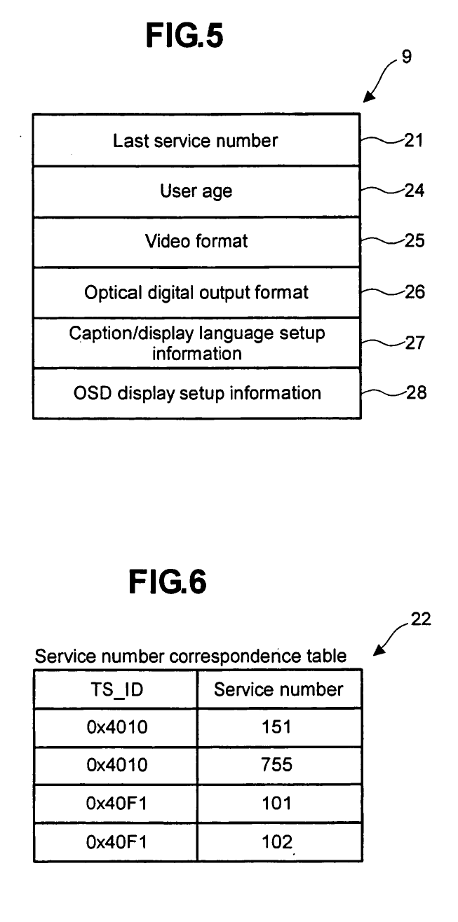

FIG. 6 is a diagram showing an example of a service number correspondence table 22. The service number correspondence table 22 is a table for associating a TS_ID (“transport_stream_id”) that is identification information of a transport stream, and a service number.

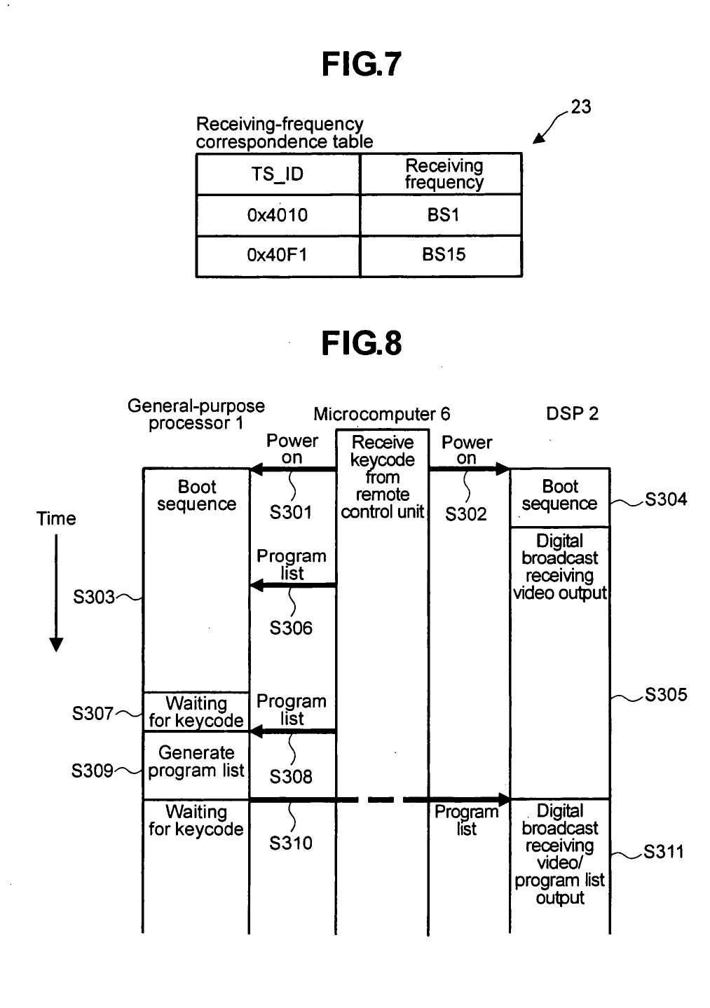

FIG. 7 is a diagram showing an example of a receiving-frequency correspondence table 23. The receiving-frequency correspondence table 23 is a table for associating the TS_ID of a transport stream, and the information identifying the radiowave-receiving frequency (relay device) used to broadcast the transport stream.

The DSP 2 can use the above-described service number correspondence table 22 and receiving-frequency correspondence table 23 to identify the TS_ID of a transport stream associated with a specific service, and the receiving frequency of radio waves associated with the service.

Startup Process for the Digital Broadcasting Receiver 100

Flow of processing during startup of the digital broadcasting receiver 100 is shown in FIG. 8. The process steps below are performed when the power to the digital broadcasting receiver 100 is off.

When the microcomputer 6 receives the “POWER” keycode (starting signal instructing a start of video output), the power supply circuit 18 supplies power to the general-purpose processor 1 and the DSP 2 to turn on the power of each in steps S301 and S302, respectively.

When power is supplied in step S301, the general-processor 1 starts a boot sequence in step S303. When power is supplied in step S302, the DSP 2 also starts a boot sequence in step S304.

Before the general-processor 1 completes the boot sequence that it started in step S303, the DSP 2 completes the boot sequence that it started in step S304. Before the general-processor 1 completes the boot sequence that it started in step S303, the DSP 2 also outputs a digital broadcasting video signal in step S305. Details of processing during the boot sequence of the DSP 2 in step S304 are described later herein.

While the general-purpose processor 1 is conducting the boot sequence in step S303, even if a keycode is transmitted from the microcomputer 6, the general-purpose processor 1 cannot conduct a process appropriate for the keycode. For example, while the general-purpose processor 1 is conducting the boot sequence, even if a keycode identifying a “PROGRAM LIST” key is transmitted from the microcomputer 6 in step S306, the general-purpose processor 1 cannot conduct a process such as generating an EPG.

On completing the boot sequence in step S304, the general-purpose processor 1 enters a “waiting for keycode” state in step S307, this state indicating that the keycode transmitted from the microcomputer 6 can be accepted. When the general-purpose processor 1 in the “waiting for keycode” state receives the “PROGRAM LIST” keycode from the microcomputer 6 in step S307, the general-purpose processor 1 generates in step S309 a second video signal for displaying an EPG on the basis of the SI (Service Information: program array information) transmitted as section data from the DSP 2. The SI indicates titles of programs, starting time of each program, and other information. The general-purpose processor 1, after generating the second video signal, transmits the signal to the DSP 2 in step S310.

In the DSP 2, the video signal receiver 207 receives the second video signal from the general-purpose processor 1, and then the video signal synthesizer 209 synthesizes the second video signal and the first video signal output from the video decoding block 206. Thus, in step S311, the video signal output from the video output block 208 of the DSP 2 becomes a signal generated by synthesizing the digital broadcasting video signal and the EPG.

During above processing, before the general-purpose processor 1 completes the boot sequence that it started in step S303, the boot sequence that was started in step S304 by the DSP 2 is completed in, for example, a case in which the startup of the operating system 12 executed by the general-purpose processor 1 becomes a time-consuming operation for reasons such as initialization. According to the digital broadcasting receiver 100 in the present embodiment, even if the startup of the operating system 12 executed by the general-purpose processor 1 is a time-consuming operation, the DSP 2 can output digital broadcasting video signals/audio signals independently of the general-purpose processor 1. Once the DSP 2 has completed the boot sequence started in step S304, therefore, the user can at least enjoy the video and audio of the digital broadcast, even during a time from completion of the boot sequence in step S304 by the general-purpose processor 1 to output of the second video signal for the EPG or BML screen or the like. This means that even when a general-purpose operating system is adopted for the digital broadcasting receiver 100, response characteristics with respect to the user can be improved.

Before the general-purpose processor 1 completes the boot sequence that it started in step S303, the boot sequence that was started in step S304 by the DSP 2 can also be completed in other cases. Examples include the cases where an operation clock of the DSP 2 is faster than that of the general-purpose processor 1 in terms of speed, where an operation speed of the flash ROM 5 is higher than that of the memory 11, and where a data size of the program 10 is greater than those of the operating system 12 and the program 13. In such cases, the digital broadcasting receiver 100 in the present embodiment can output the video and audio signals of a digital broadcast before the general-purpose processor 1 completes the boot sequence that it started in step S303.

Additionally, in the digital broadcasting receiver 100 of the present embodiment, the microcomputer 6 can directly transmit to the DSP 2 the keycode that the microcomputer received from the remote control unit 200, and the DSP 2 can change a data setting of the receiving frequency of the digital broadcasting tuner 3 in response to the keycode without undergoing the control of the general-purpose processor 1. Before the boot sequence of the general-purpose processor 1 is completed, therefore, the DSP 2 can accept the instruction input from the remote control unit 200 by the user, and change the kind of service to be output. Response characteristics with respect to and convenience of the user can thus be improved.

Program Specific Information (PSI)

In the boot sequence, the DSP 2 sets up the digital broadcasting tuner 3 for operation, in accordance with the setup information 9 and other information stored within the NVRAM 4, and starts decoding the transport stream output from the digital broadcasting tuner 3. Description is given below of PSI (Program Specific Information), data required for the DSP 2 to receive a transport stream associated with a desired service.

Major constituent elements of PSI include PMT (Program Map Table) for acquiring a packet identification code (PID) for the transport packet in which an elementrary stream associated with a specific service is stored, and PAT (Program Association Table) for extracting PMT from the transport stream.

FIG. 9 is a diagram showing an example of PAT. PAT is stored in a transport packet whose PID is “0x0000”. In PAT, a service number 71 and a PID 72 for identifying the transport packet in which PMT is stored are set in an associated condition.

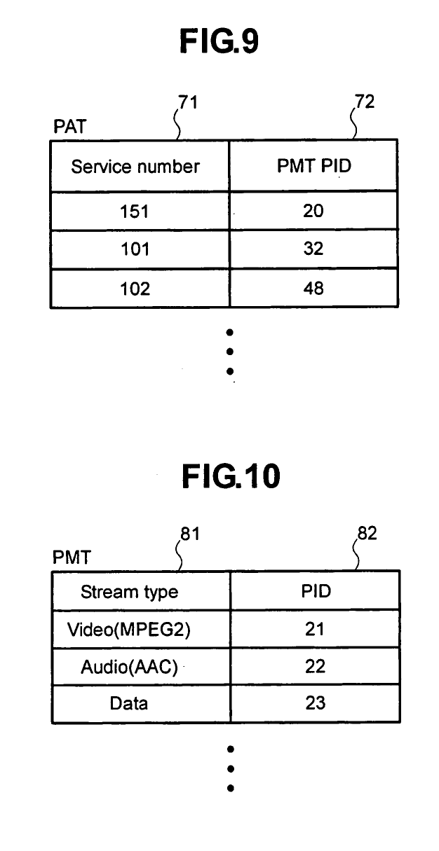

FIG. 10 is a diagram showing an example of PMT. In PMT, a stream type 81 that indicates the type of elementary stream, and a PID 82 that identifies the transport packet in which the elementary stream is stored are set in an associated condition. The type of elementary stream, such as “video”, “audio”, or “caption”, and a data format such as “MPEG1/2/4” or “AAC” are set in combined form in the stream type 81.

By referring to PAT and PMT, the DSP 2 can acquire the PID of the transport packet for acquiring an elementary stream associated with a specific service, the kind of elementary stream supplied through the particular service, an encoded data format, and other information.

Boot Sequence of the DSP 2

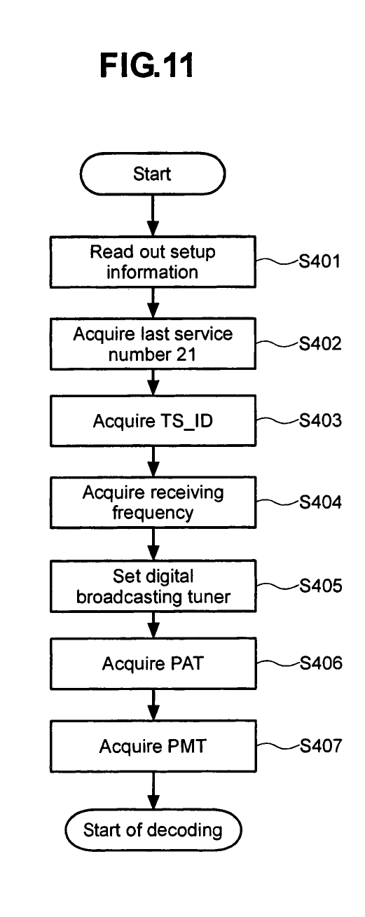

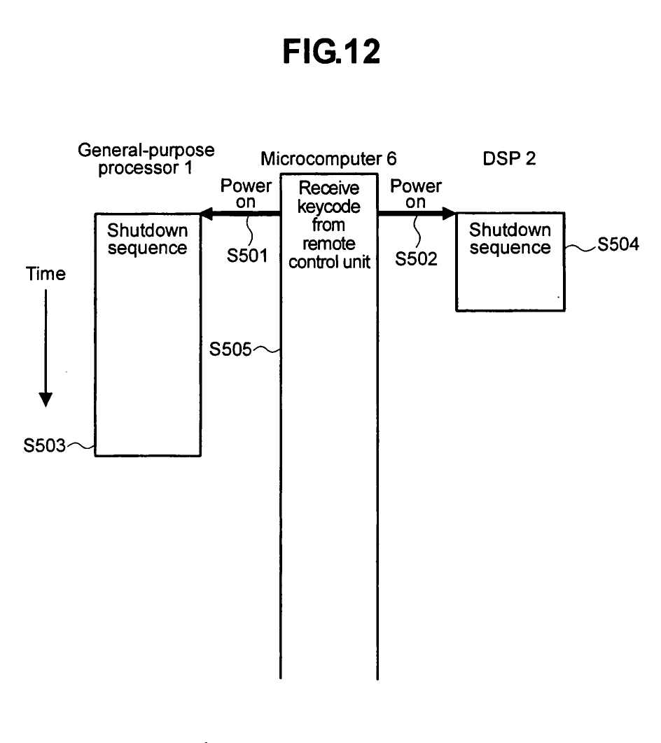

Flow of processing during the boot sequence of the DSP 2 is shown in FIG. 11.

In step S401, the setup information readout block 212 reads setup information 9 out from the NVRAM 4, and in step S402, acquires the service number set in the last service number field 21 of the setup information 9. In step S403, the setup information readout block 212, with the thus-acquired service number as its key, acquires TS_ID from the service number correspondence table 22. In step S404, the setup information readout block 212, with the thus-acquired TS_ID as its key, further acquires a receiving frequency from the receiving-frequency correspondence table 23. In step S405, the tuner control block 211 controls the digital broadcasting tuner 3 so as to receive radio waves of the receiving frequency acquired. This makes it possible for the DSP 2 to receive from the digital broadcasting tuner 3 the transport stream appropriate for the service number set in the last service number field 21 of the setup information 9.

Next, the TS decoding block 202 acquires PAT in step S406 by extracting the transport packet whose PID is “0x0000”. The TS decoding block 202, with the service number in the last service number field 21 of the setup information 9 as an acquisition key, acquires from PAT the PID of the transport packet in which PMT is stored. The TS decoding block 202 acquires PMT in step S407 by extracting the transport packet for which is set the same PID as the acquired PID.

By executing above processing, the TS decoding block 202 can acquire the PID of the elementary stream set in PMT, and extract the transport packet in which the acquired PID is set, from the transport stream received from the digital broadcasting tuner 3. Thus, the DSP 2 can start decoding the transport stream.

Flow of transport stream decoding in the DSP 2 is described below. The TS decoding block 202 connects the data stored in a payload part 62 of the extracted transport packet, and reconstructs elementary streams. The audio decoding block 204 decodes an audio elementary stream, and the audio output block 207 outputs a decoded audio signal. The video decoding block 206 decodes the video and caption elementary streams that the TS decoding block 202 has reconstructed, and the audio output block 207 outputs a decoded first video signal. When the value instructing the caption to be displayed is already set in the caption/display language information field 27 of the setup information 9, the video decoding block 206 decodes the video and caption elementary streams. Also, the video signal synthesizer 209 synthesizes the video signals of the video and caption data, and the video output block 207 outputs the signal generated by the synthesis of the video signals.

According to the digital broadcasting receiver 100 of the present embodiment, the DSP 2 conducts the above-described boot sequence and transport stream decoding independently of the general-purpose processor 1. The DSP 2 can therefore conduct transport stream decoding before the general-purpose processor 1 completes the boot sequence. Accordingly, the user can view the digital broadcast without waiting for the general-purpose processor 1 to be started up. This means that even if a time is required for output of the image information contained in the EPG or OSD screen generated by the general-purpose processor 1, the user can at least enjoy the video and audio of the digital broadcast or of the audio broadcast.

Terminating Process for the Digital Broadcasting Receiver 100

Flow of the processing executed when the power to the digital broadcasting receiver 100 is turned off is described below. Processing described below is conducted when the power to the digital broadcasting receiver 100 is on.

When the microcomputer 6 receives the “POWER” keycode (stopping signal that instructs a stop of video signal output), the microcomputer 6 transmits the keycode to the general-purpose processor 1 and the DSP 2 each in steps S501 and S502, respectively. After receiving the “POWER” keycode in step S501, the general-purpose processor 1 starts a shutdown sequence in step S503. The DSP 2 also starts a shutdown sequence in step S504 after receiving the “POWER” keycode in step S502.

In the shutdown sequence, the setup information writing block 213 of the DSP 2 sets in the last service number field 21 of the setup information 9 the service number of the service which was output immediately before the shutdown sequence was started, and writes the setup information 9 into the NVRAM 4. Thus, in the boot sequence conducted when the digital broadcasting receiver 100 is started up next time, the DSP 2 can output the video signal and audio signal of the same service as the service which was output immediately before the shutdown sequence.

### EXAMPLE OF MODIFICATION

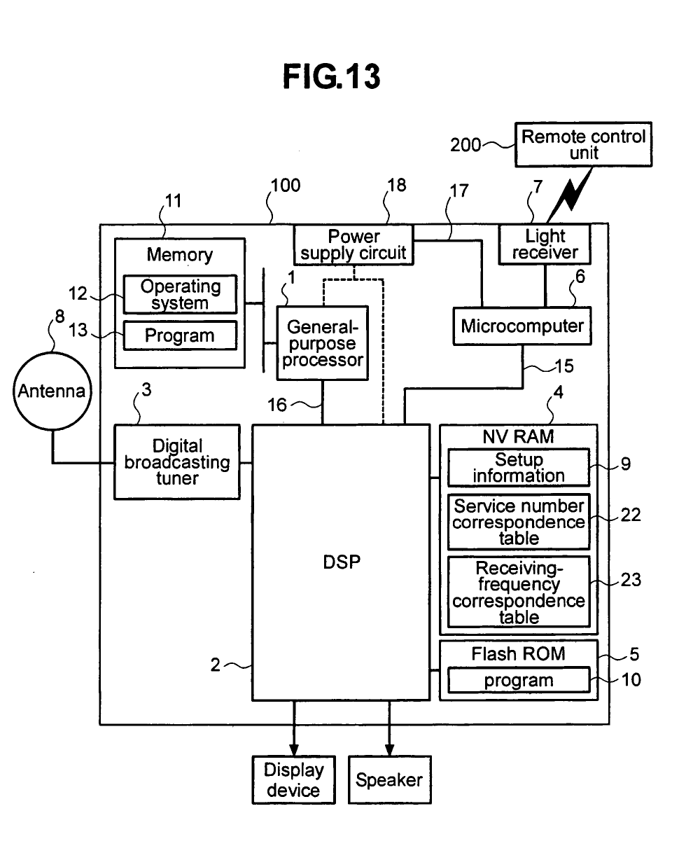

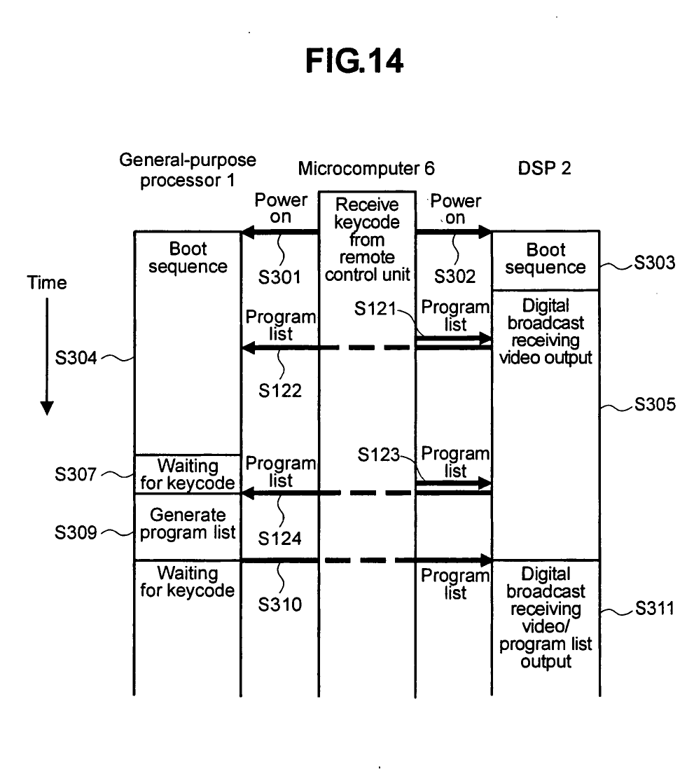

A digital broadcasting receiver 100 according the present embodiment may, as shown in FIG. 13, not have a bus 14 for connecting a microcomputer 6 and a general-purpose processor 1. In this case, the microcomputer 6, after receiving a keycode from a remote control unit 200, transmits the keycode to a DSP 2 via a bus 15, and then the DSP 2 transfers the keycode from the microcomputer 6 to the general-purpose processor 1 via a bus 16. Flow of processing during startup of the digital broadcasting receiver 100 according to the present embodiment is shown in FIG. 14. Processing described below is conducted when the power to the digital broadcasting receiver 100 is off.

When the microcomputer 6 receives a “POWER” keycode, a power supply circuit 18 supplies electric power to the general-purpose processor 1 and the DSP 2 each in steps S301 and S302, respectively. When power is supplied in step S301, the general-processor 1 starts a boot sequence in step S303. When power is supplied in step S302, the DSP 2 also starts a boot sequence in step S304.

Before the boot sequence that the general-purpose processor 1 started in step S303 is completed, the DSP 2 completes the boot sequence that it started in step S304, and outputs a digital broadcasting video signal in step S305.

On completing the boot sequence in step S304, the general-purpose processor 1 enters a “waiting for keycode” state in step S307, this state indicating that the keycode transmitted from the microcomputer 6 can be accepted. When the general-purpose processor 1 in the “waiting for keycode” state receives the “PROGRAM LIST” keycode transferred from the DSP 2 following completion of transmission of the “PROGRAM LIST” keycode from the microcomputer 6 to the DSP 2 in step S123, the general-purpose processor 1 generates in step S309 a second video signal for displaying an EPG on the basis of SI which is one type of section-format data received from the DSP 2. The general-purpose processor 1, after generating the second video signal, transmits the signal to the DSP 2 in step S310. In the DSP 2, a video signal receiver 207 receives the second video signal from the general-purpose processor 1, and then a video signal synthesizer 209 synthesizes the second video signal and the video signal output from a video decoding block 206. Thus, in step S311, the video signal output from a video output block 208 of the DSP 2 becomes a signal generated by synthesizing the digital broadcasting video signal and the EPG.

During the heretofore described starting process for the digital broadcasting receiver 100 of the present embodiment, the keycode that was transmitted from the remote control unit 200 is taken as the keycode for a “PROGRAM LIST” key. A similar process also applies to a case in which, for example, the keycode indicates a “MENU” key that instructs display of a GUI for a user to set up the digital broadcasting receiver 100 for operation, or in which the keycode indicates a “DATA BROADCAST” key that instructs display of a BML screen.

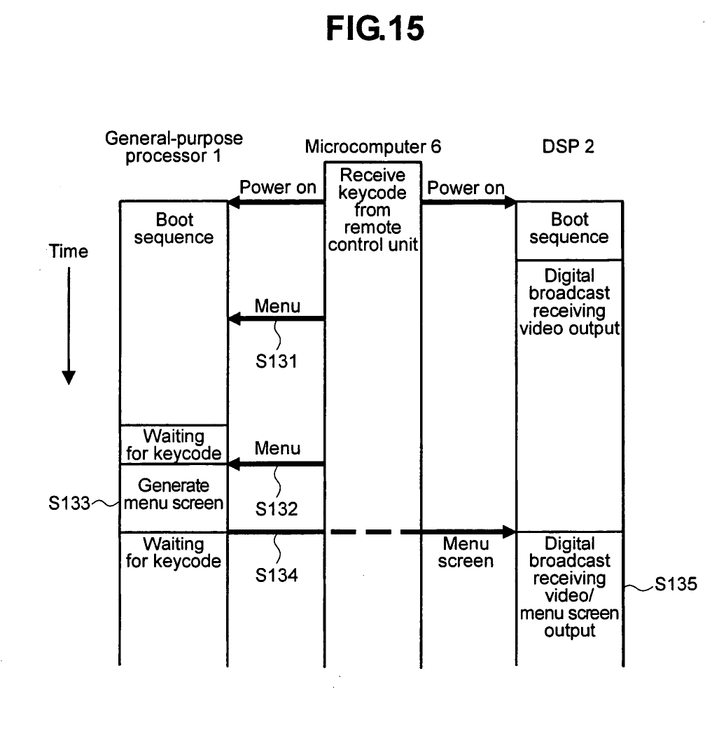

Flow of processing in the case where the transmitted keycode from the remote control unit 200 indicates the “MENU” key is shown in FIG. 15. When the keycode that was received from the remote control unit 200 in step S132 indicates the “MENU” key, the general-purpose processor 1 generates in step S133 a GUI (hereinafter, referred to as the menu screen) that accepts user input of the setup information relating to the digital broadcasting receiver 100. In step S134, the general-purpose processor 1 transmits to the DSP 2 a second video signal used to display the menu screen, and in step S135, the DSP 2 synthesizes the second video signal with a first video signal and then outputs the resulting signal.

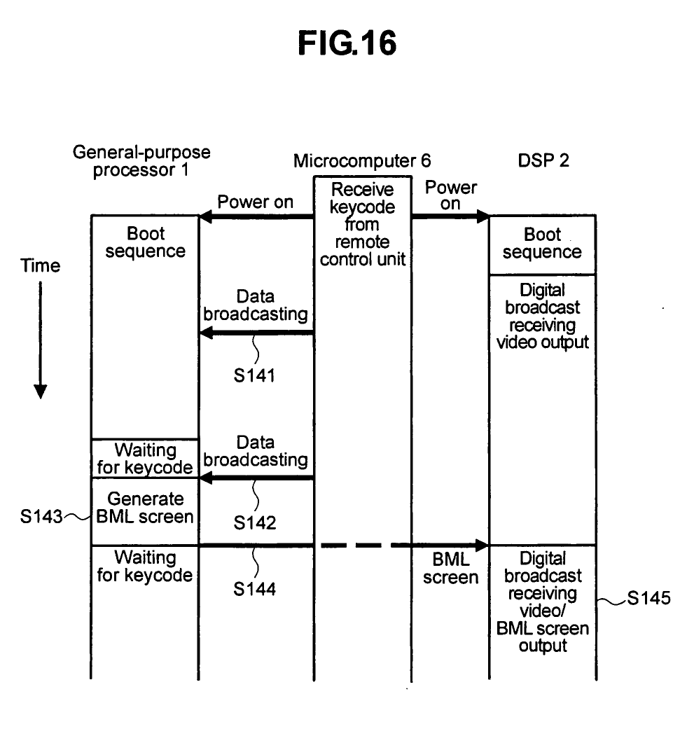

Flow of processing in the case where the transmitted keycode from the remote control unit 200 indicates the “DATA BROADCAST” key that instructs display of a BML screen is shown in FIG. 16. When the keycode that was received from the remote control unit 200 in step S142 indicates the “DATA BROADCAST” key, the general-purpose processor 1 retrieves a BML document from a transport packet in which is stored the section data that was received from the remote control unit 200. Next, in step S143, the general-purpose processor 1 analyzes the retrieved BML document and generates an MBL screen. In step S144, the general-purpose processor 1 transmits to the DSP 2 a second video signal used to display the BML screen, and in step S145, the DSP 2 synthesizes the second video signal with a first video signal and then outputs the resulting signal.

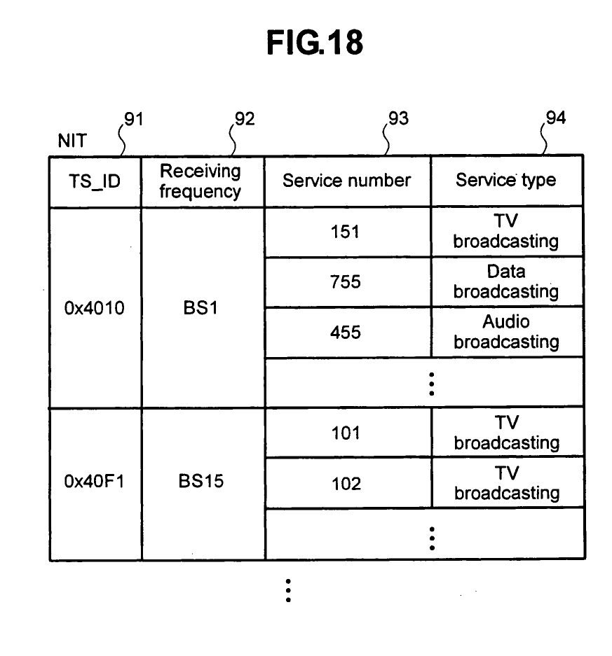

In the digital broadcasting receiver 100 of the present embodiment, in order for the DSP 2 to be able to start transport stream decoding rapidly, the DSP 2 is composed so that TS_ID of a transport stream associated with a specific service, and a receiving frequency of radio waves are acquired from the service number correspondence table 22 and receiving-frequency correspondence table 23 stored in an NVRAM 4. The DSP 2, however, may otherwise be composed so that the above TS_ID and transport stream are acquired from NIT (Network Information Table), one constituent element of PSI. FIG. 18 is a diagram showing an example of NIT. NIT is stored in a transport packet whose PID is “0x0010”. In NIT, a receiving frequency 92 for receiving the transport stream is set in an associated state with respect to a TS_ID 91 identifying the transport stream. In NIT, a service number 93 and a service type 94 which is service type information identifying the service are also set in an associated state for all services includes in the transport stream appropriate for the TS_ID 91.

The service number correspondence table 22 and receiving-frequency correspondence table 23 stored in the NVRAM 4 can also be updated using the above NIT. In this case, the latest service number correspondence table 22 and receiving-frequency correspondence table 23 can be maintained.

In addition, if a viewing condition, such as an age limit, exists for the service being received a TS decoding block 202 of the DSP 2 may be composed so as to judge whether the user age set as an attribute in the digital broadcasting receiver 100 matches the condition, and discard the transport packet if the condition is not satisfied. In this case, the TD decoding block 202 acquires, for example, CAT (Conditional Access Table) that is one constituent element of PSI, and depending on whether the value set in a user age field 24 of setup information 9 stays within an age limit range specified in CAT, judges whether the age of the user matches the viewing condition.

A value indicating whether the user has paid for using a payment-based service may also be set in the setup information 9 as a further attribute of the user. In this case, if key information for de-scrambling a scrambled elementary stream is stored into the NVRAM 4, the TS decoding block 202 can de-scramble the elementary stream by using the key information.

Furthermore, although the power supply circuit 18 in the present embodiment supplies power on receiving a power-on signal from the microcomputer 6, this does not limit the present invention, and, for example, a switch allowing the user to turn on/off the digital broadcasting receiver 100 may be provided so that when the switch itself is turned on, the power supply circuit 18 will supply power. In this case, the switch functions as a user interface that accepts user input. The digital broadcasting receiver 100 itself may otherwise have a button or a liquid-crystal display screen (or the like) to realize the user interface, in which case, the user operates the digital broadcasting receiver 100 by pressing the above button instead of using the remote control unit 200.

Furthermore, although the video signal synthesizer 209 of the DSP 2 in the present embodiment synthesizes a first video signal and a second video signal, a circuit for synthesizing the video signals may be provided as an video signal synthesizing circuit independent of the DSP 2. In this case, the video signal synthesizing circuit accepts input of the first video signal output from the DSP 2, and input of the second video signal output from the general-purpose processor 1, and outputs the signal generated by the synthesis, to an external output device such as a display device. In this case, since a processing load on the DSP 2 can be reduced, the digital broadcasting receiver 100 can be further improved in response characteristics.

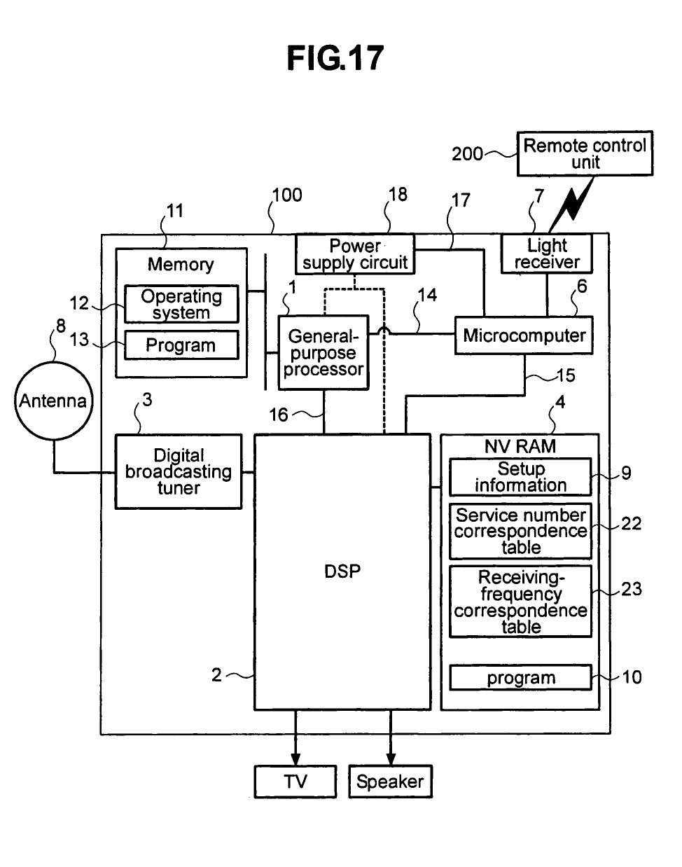

Furthermore, although, in the digital broadcasting receiver 100 of the present embodiment, the program 10 is stored into the flash ROM 5, the program 10 may be stored into the NVRAM 4 instead. The circuit composition applied in this case is shown in FIG. 17. Although using the flash ROM 5 is less expensive than using the NVRAM 4, the program 10 can also be stored into the NVRAM 4 more tolerant against update operations under the situation where the program 10 is to be subjected to frequent update operations such as upgrading.

Besides, although the operation heretofore described applies to the startup of the digital broadcasting receiver 100, the same is also applicable to the return process conducted when the digital broadcasting receiver 100 returns from standby mode.

Furthermore, although the digital broadcasting receiver 100 in the present embodiment outputs signals to an external output device such as a display device or loudspeaker, the digital broadcasting receiver 100 can not only output signals to the output device, but also write the signals onto a recording medium such as a hard disk, magnetic tape, or DVD-R disk. In other words, the present invention is also applicable to a digital broadcast recording device.

Furthermore, the digital broadcasting receiver 100 in the present embodiment can also be easily configured as a TV apparatus having a display device.

While the present embodiment has been described above, the embodiment is for a better understanding of the present invention and is not for restrictive interpretation of the invention. It may be possible to introduce modifications/improvements in the invention without departing from the spirit thereof, and equivalents of the modifications/improvements are embraced in the invention.

1. A digital broadcasting receiver comprising:
a tuner operable to produce a demodulated signal from a received digital broadcast signal;
a digital signal processor in communication with the tuner to receive the demodulated signal, and configured to produce a first video signal that can be communicated to an external device;
a general-purpose processor operable to generate a second video signal;
a video combiner to combine the first video signal with the second video signal to produce a combined signal; and
an input circuit operable to receive a first signal from a first external device,
wherein the digital signal processor and the general-purpose processor each initiate a boot sequence in response to the input circuit receiving the first signal,
wherein the digital signal processor begins receiving the demodulated signal from the tuner and produces the first video signal before the general-purpose processor completes its boot sequence, whereby the first video signal can be communicated to a second external device before the general-purpose processor completes its boot sequence.

2. The digital broadcasting receiver of claim 1 wherein subsequent to the general-purpose processor completing its boot sequence, the general-purpose processor produces the second video signal and the video combiner produces the combined signal.

3. The digital broadcasting receiver of claim 1 wherein the second video signal is a signal for displaying a program list of the digital broadcast.

4. The digital broadcasting receiver of claim 1 wherein the second video signal is a signal for displaying a user interface for setting up the digital broadcasting receiver.

5. The digital broadcasting receiver of claim 1 wherein the second video signal is a signal for displaying data based on broadcast markup language (BML).

6. The digital broadcasting receiver of claim 1 wherein the boot sequence of the general-purpose processor includes starting an operating system.

7. The digital broadcasting receiver of claim 1 further comprising a remote control signal handler operative to receive first keycode information indicative of a key press action performed on a remote control unit, wherein the digital signal processor controls the tuner in response to receipt of the first keycode irrespective of whether or not the boot sequence of the general-purpose processor has completed.

8. The digital broadcasting receiver of claim 1 further comprising a nonvolatile access memory to store service information that identifies a service of the digital broadcast,
wherein, in response to the input circuit receiving a second signal, the digital signal processor is operative to cease producing the first video signal and to store service information associated with the first video signal to the nonvolatile memory,
wherein, in response to the input circuit receiving a third signal, the digital signal processor is operative to read out service information stored in the nonvolatile memory, to control the tuner according to the service information that was read out to produce a second demodulated signal from the received digital broadcast signal, and to decode the second demodulated signal,
wherein the digital signal processor can respond to either of the second or third signals during a period of time prior to the general-purpose processor completing its boot sequence.

9. The digital broadcasting receiver according to claim 1 further comprising a nonvolatile access memory to store attribute information associated with a user, the digital signal processor operative to acquire viewing condition information from the demodulated signal, and to determine whether to produce the first video signal or not based on a comparison of the attribute information of the user with the viewing condition information.

10. The digital broadcasting receiver according to claim 1 further comprising a nonvolatile access memory to store setup information that is used by the digital signal processor to decode the demodulation signal, wherein in further response to the input circuit receiving the first signal the digital signal processor reads out the setup information and decodes the modulated signal according to the setup information, wherein the digital signal processor can read out the setup information from the nonvolatile memory prior to the general-purpose processor completing its boot sequence.

11. The digital broadcasting receiver according to claim 10, wherein the setup information includes aspect ratio information of the first video signal.

12. The digital broadcasting receiver according to claim 10, wherein the setup information includes an indication whether a caption is to be displayed along with the first video signal.

13. The digital broadcasting receiver according to claim 1, further including a nonvolatile access memory to store service information that identifies a service of the digital broadcast and frequency information that identifies a frequency at which a signal associated with the service information is being broadcast, wherein in further response to the input circuit receiving the first signal the digital signal processor reads out frequency information associated with a specific service, controls said tuner according to the frequency information acquired, and starts decoding the demodulation signal to produce the first video signal, wherein the digital signal processor can read out the frequency information from the nonvolatile memory prior to the general-purpose processor completing its boot sequence.

14. A television apparatus comprising:
a tuner for receiving a digital broadcast signal, the tuner operative to produce a demodulated signal from a received digital broadcast signal;
a digital signal processor for decoding the demodulated signal to produce a first video signal;
a display means for presenting the first video signal;
a general-purpose processor operative to generate a second video signal;
a video combiner operative to combine the first video signal and the second video signal to produce a third video signal; and
an input circuit operable to receive a start signal,
wherein the digital signal processor and the general-purpose processor each initiate an initialization sequence, in response to the start signal,
wherein the digital signal processor can begin decoding the demodulated signal before the boot sequence of the general-purpose processor is completed.

15. The television apparatus according to claim 14 wherein the start signal is produced by an external device and communicated to the television apparatus.

16. The television apparatus according to claim 14, wherein the second video signal is produced at a time subsequent to the general-purpose processor completing its boot sequence, the video combiner thereby producing the third video signal.

17. The television apparatus according to claim 14, further comprising a remote control signal handler operative to receive first keycode information indicative of a key press action performed on a remote control unit, wherein the digital signal processor can control the tuner in response to receipt of the first keycode if the first keycode is receive before the boot sequence of the general-purpose processor has completed.

18. A method of controlling a digital broadcasting receiver comprising:
receiving a digital broadcast signal;
generating a demodulated signal from the digital broadcast signal;
receiving a start signal;
in response to receiving the start signal, initiating a boot sequence in a digital signal processor and initiating a boot sequence in a general-purpose processor, the digital signal processor completing its boot sequence before the general-purpose processor completes its boot sequence;
after completing the boot sequence in the digital signal processor, operating the digital signal processor to decode the demodulated signal to produce a first video signal; and
after completing the boot sequence in the general-purpose processor, operating the general-purpose processor to produce a second video signal, wherein the second video signal can be combined with first digital video signal,
wherein the digital signal processor can decode the demodulated signal to produce the first video signal prior to completion of the boot sequence of the general-purpose processor.

19. The method of claim 18 further comprising combining the first video signal with the second video signal to produce a combined video signal that can be presented on a video display.

20. The method of claim 18 further comprising operating the tuner to generate a second demodulated signal in response to receiving a control signal from a remote control device, wherein the second demodulated signal can be generated at a time prior to completion of the boot sequence of the general-purpose processor.
